(19) United States
(12) Patent Application Publication
(10) Pub. No.: US 2016/0077121 A1
(43) Pub. Date: Mar. 17, 2016

(54) APPARATUS AND METHOD FOR MEASURING SPEED OF MDPS DRIVE MOTOR

(71) Applicant: HYUNDAI MOBIS CO., LTD., Seoul (KR)

(72) Inventor: Jae Hyun LEE, Anyang-si (KR)

(21) Appl. No.: 14/701,444

(22) Filed: Apr. 30, 2015

(30) Foreign Application Priority Data
Sep. 15, 2014 (KR) 10-2014-0122089

(51) Int. Cl. G01P 3/00; B62D 5/04

(52) U.S. Cl. CPC G01P 3/00; B62D 5/046

(57) ABSTRACT

A method for measuring speed of an MDPS drive motor may include: receiving, by a controller, A and B pulses having a phase difference of 90 degrees from an encoder during a first reference time, and measuring information of the pulses; receiving A and B pulses having a phase difference of 90 degrees from the encoder again during the first reference time, and remeasuring information of the pulses; selecting any one of the measured pulse information and the remeasured pulse information as data for calculating the speed of the motor, based on the measured pulse information and the remeasured pulse information; and calculating the speed of the motor, based on the selected data.

### CROSS-REFERENCES TO RELATED APPLICATIONS

The present application claims priority to Korean application number 10-2014-0122089, filed on Sep. 15, 2014, which is incorporated by reference in its entirety.

### BACKGROUND

The present disclosure relates to an apparatus and method for measuring speed of a motor driven power steering (MDPS) drive motor, using an incremental encoder.

Power steering of a vehicle is a steering apparatus based on power, and assists a driver to operate a steering wheel. Such power steering generally uses hydraulic pressure. Recently, however, the use of an MDPS system which uses the force of a motor has increased. That is because the MDPS system has a smaller weight and occupies a smaller area than existing hydraulic power steering systems, and does not require an oil change.

The related art is disclosed in Korean Patent Laid-open Publication No. 10-2004-0017954 published on Mar. 2, 2004.

### SUMMARY

Embodiments of the present invention are directed to an apparatus and method for measuring speed of an MDPS drive motor, capable of precisely measuring speed while having a constant speed measurement cycle, without an additional component such as a latch.

In one embodiment, a method for measuring speed of an MDPS drive motor may include: receiving, by a controller, A and B pulses having a phase difference of 90 degrees from an encoder during a first reference time, and measuring information of the pulses; receiving A and B pulses having a phase difference of 90 degrees from the encoder again during the first reference time, and remeasuring information of the pulses; selecting any one of the measured pulse information and the remeasured pulse information as data for calculating the speed of the motor, based on the measured pulse information and the remeasured pulse information; and calculating the speed of the motor, based on the selected data.

The pulse information may include a pulse number obtained by multiplying the number of the A and B pulses by four, information on the cycle of the A pulse, information on the cycle of the B pulse, and a pulse state. In the selecting of any one of the measured pulse information and the remeasured pulse information as the data for calculating the speed of the motor, the controller may select the measured pulse information as the data for calculating the speed of the motor when the multiplied-by-four pulse number contained in the measured pulse information is equal to the multiplied-by-four pulse number contained in the remeasured pulse information, and select the remeasured pulse information as the data for calculating the speed of the motor when the multiplied-by-four pulse number contained in the measured pulse information is different from the multiplied-by-four pulse number contained in the remeasured pulse information.

The calculating of the speed of the motor may include: estimating, by the controller, a half-cycle time of any one of the A and B pulses, based on the selected data; when the multiplied-by-four pulse number contained in the selected data is equal to or more than a reference number, calculating the speed of the motor based on the multiplied-by-four pulse number contained in the selected data and the estimated time; and when the multiplied-by-four pulse number contained in the selected data is less than the reference number, determining the speed of the motor based on the continuance time during which the pulse number is less than the reference number.

The determining of the speed of the motor may include: setting, by the controller, the speed of the motor to 0 when the continuance time exceeds a second reference time; and maintaining the speed of the motor when the continuance time does not exceed the second reference time.

The calculating of the speed of the motor may include: estimating, by the controller, a half-cycle time of any one of the A and B pulses based on the selected data, when the multiplied-by-four pulse number contained in the selected data is equal to or more than a reference number; calculating the speed of the motor based on the multiplied-by-four pulse number contained in the selected data and the estimated time; setting the speed of the motor to 0, when the multiplied-by-four pulse number contained in the selected data is less than the reference number and the continuance time during which the pulse number is less than the reference number exceeds the second reference time; and maintaining the speed of the motor, when the multiplied-by-four pulse number contained in the selected data is less than the reference number and the continuance time during which the pulse number is less than the reference number does not exceed the second reference time.

The pulse state may be divided into when the A pulse is high and the B pulse is low (S1), when the A pulse is low and the B pulse is high (S2), when both of the A and B pulses are high (S3), and when both of the A and B pulses are low (S4), and the estimating of the half-cycle time may include: determining, by the controller, the rotation direction of the motor based on a pulse state contained in the selected data; estimating the half-cycle time of the A pulse, when the determined rotation direction of the motor is forward and the last value of the pulse state contained in the selected data is any one of S1 and S2; estimating the half-cycle time of the B pulse, when the rotation direction is forward and the last value is any one of S3 and S4; estimating the half-cycle time of the B pulse, when the rotation direction is backward and the last value is any one of S1 and S2; and estimating the half-cycle time of the A pulse, when the rotation direction is backward and the last value is any one of S3 and S4.

In the calculating of the speed of the motor, the controller may calculate the RPM of the motor through the following equation:

$$\frac{15 \times pulse number}{PPR \times ( first reference time + \frac{half cycle time}{2} )}$$

where PPR represents the number of output pulses per revolution of the encoder.

In another embodiment, a method for measuring speed of an MDPS drive motor may include: receiving, by a controller, A and B pulses having a phase difference of 90 degrees from an encoder during a first reference time, and measuring a multiplied-by-four pulse number and a multiplied-by-four pulse cycle; when the measured pulse number is equal to or more than a reference number, calculating the speed of the motor based on the measured pulse number and the measured pulse cycle; and when the measured pulse number is less than the reference number, determining the speed of the motor based on a continuance time during which the pulse number is less than the reference number.

The determining of the speed of the motor may include: setting, by the controller, the speed of the motor to 0, when the continuance time exceeds a second reference time; and maintaining the speed of the motor, when the continuance time does not exceed the second reference time.

In the calculating of the speed of the motor, the controller calculates the RPM of the motor through the following equation:

$$\frac{15 \times pulse number}{PPR \times ( first reference time + pulse cycle )}$$

where PPR represents the number of output pulses per revolution of the encoder.

In another embodiment, an apparatus for measuring speed of an MDPS drive motor may include: an encoder configured to output A and B pulses having a phase difference of 90 degrees, as the motor is rotated; and a controller configured to measure information of A and B pulses received from the encoder during a first reference time, then remeasure information of A and B pulses received from the encoder again during the first reference time, select any one of the measured pulse information and the remeasured pulse information as data for calculating the speed of the motor, based on the measured pulse information and the remeasured pulse information, and calculate the speed of the motor based on the selected data.

The pulse information may include a pulse number obtained by multiplying the number of the A and B pulses by four, information on the cycle of the A pulse, information on the cycle of the B pulse, and a pulse state. When selecting the data for calculating the speed of the motor, the controller may select the measured pulse information as the data for calculating the speed of the motor in case where the multiplied-by-four pulse number contained in the measured pulse information is equal to the multiplied-by-four pulse number contained in the remeasured pulse information, and select the remeasured pulse information as the data for calculating the speed of the motor in case where the multiplied-by-four pulse number contained in the measured pulse information is different from the multiplied-by-four pulse number contained in the remeasured pulse information.

### BRIEF DESCRIPTION OF THE DRAWINGS

FIG. 1 is a diagram for describing methods for measuring speed of a motor, using an incremental encoder.

FIG. 2 is a block diagram illustrating the configuration of an apparatus for measuring speed of an MDPS drive motor in accordance with an embodiment of the present invention.

FIG. 3 is a diagram for describing pulses outputted from an encoder in the apparatus for measuring speed of the MDPS drive motor in accordance with an embodiment of the present invention.

FIG. 4 is a flowchart for describing a method for measuring speed of an MDPS drive motor in accordance with an embodiment of the present invention.

FIG. 5 is a flowchart for describing a step of selecting data for calculating the speed of a motor in the method for measuring speed of an MDPS drive motor in accordance with the embodiment of the present invention.

FIG. 6 is a flowchart for describing a step of calculating the speed of the motor in the method for measuring speed of an MDPS drive motor in accordance with the embodiment of the present invention.

FIG. 7 is a diagram comparatively illustrating a speed measurement result of the method for measuring speed of an MDPS drive motor in accordance with the embodiment of the present invention and a speed measurement result of another comparative method.

### DESCRIPTION OF EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions into account and can be changed according to the custom or intention of users or operators. Therefore, definition of the terms should be made according to the overall disclosures set forth herein.

Generally, unlike the existing hydraulic power steering systems, the MDPS system generates a torque through current control of the motor by a control unit such as an electronic control unit (ECU), and thus includes various control logics for controlling the motor. Such control logics are divided into logic for realizing a steering feel desired by a driver, logic for improving the stability of the vehicle, and logic for improving the stability of the system. The control unit of the MDPS system performs the respective logics based on various parameters such as a vehicle speed, a torque signal, and a steering angle signal.

Among the parameters, a steering angle and a steering angle speed are necessary parameters for realizing a delicate steering feel, and can be calculated by pre-processing a signal measured through a steering angle sensor installed on a column assembly. However, since a generally used steering angle sensor has a low resolution, the steering angle sensor has difficulties in acquiring a delicate steering feel. Thus, the steering angle sensor generally calculates a column angle speed by converting an angular speed of the motor. Thus, it is important to precisely measure the speed of the drive motor, in order to precisely control the MDPS system.

In general, the speed of the motor is measured through a rotary encoder. The rotary encoder includes an absolute encoder which outputs the absolute position of a shaft and an incremental encoder which outputs information on a motion of the shaft. When measuring the speed of the motor, the incremental encoder is mainly used.

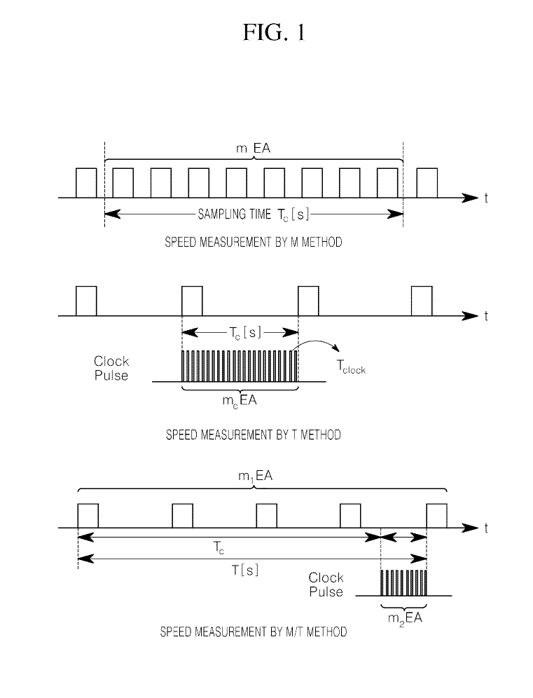

The method for measuring the speed of a motor using such an incremental encoder may be roughly divided into three methods such as an M method, a T method, and an M/T method, as illustrated in FIG. 1. The M method indicates a method for calculating the speed of a motor by counting the number of pulses outputted from an encoder during a predetermined sampling time. The M method can be simply implemented, and has an unchangeable speed measurement cycle. However, since a speed error may occur depending on whether the sampling time is synchronized with an encoder pulse, the M method has relatively low precision.

The T method indicates a method for calculating the speed of a motor by measuring the time between output pulses of the encoder. The T method can precisely measure the speed of the motor at a low-speed region. However, the T method requires a high-frequency clock pulse in order to precisely measure speed at a high-speed region. In this case, since the number of clock pulses to be counted at a low-speed region significantly increases, the production cost inevitably increases. Furthermore, according to the speed of the motor at an ultra low-speed region, the speed measurement cycle may be changed.

Finally, the M/T method indicates a method for calculating the speed of a motor by counting the number of pulses outputted from the encoder during a predetermined sampling time, like the M method. However, when the sampling time and an encoder pulse are not synchronized with each other, the M/T method additionally measures the time at which the next pulse is outputted, and removes an error. The M/T method can relatively accurately measure speed. However, since it is very complex and difficult to implement the M/T method, the production cost inevitably increases. Furthermore, since the time at which the next pulse is outputted is delayed from the sampling time at an ultra low-speed region, the speed measurement cycle may be changed.

The reason that the MDPS system measures the speed of the motor is in order not to simply check the speed of the motor, but to perform control logic of the motor based on the measured speed. Thus, it is important to measure the speed of the motor at each predetermined cycle without a change of the speed measurement cycle.

Furthermore, the MDPS drive motor is required to operate in a very wide speed range. In particular, the characteristic of the MDPS drive motor at an ultra low-speed region becomes an important performance evaluation factor. Furthermore, when the vehicle goes straight, a driver may not perform a steering operation for a considerably long time. Thus, a counter overflow must not occur.

Thus, although the T method or the M/T method can measure speed more accurately than the M method, the T method or the M/T method is not necessarily superior to the M method, when measuring the speed of the MDPS drive motor. In general, MDPS systems which are mass-produced measure the speed of a motor using the M method. However, when the M method is used, it is difficult to precisely measure the speed of the motor as described above.

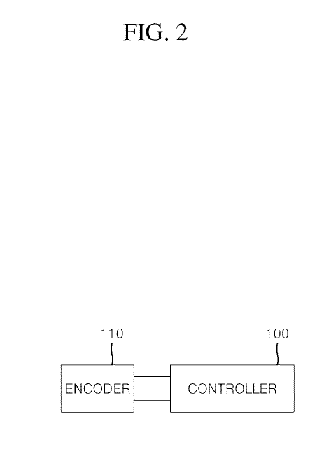

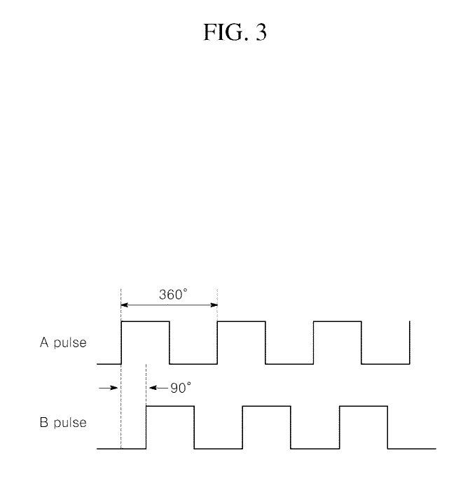

FIG. 2 is a block diagram illustrating the configuration of an apparatus for measuring speed of an MDPS drive motor in accordance with an embodiment of the present invention. FIG. 3 is a diagram for describing pulses outputted from an encoder in the apparatus for measuring speed of the MDPS drive motor in accordance with an embodiment of the present invention. Referring to FIGS. 2 and 3, the apparatus for measuring speed of an MDPS drive motor in accordance with the embodiment of the present invention will be described as follows.

First, as illustrated in FIG. 2, the apparatus for measuring speed of an MDPS drive motor in accordance with the embodiment of the present invention may include a controller 100 and an encoder 110.

The encoder 110 may output an A pulse and a B pulse according to rotation of a motor. Furthermore, the encoder 110 may output A and B pulses of which the number corresponds to one revolution of the motor, that is, pulses per revolution (PPR). Thus, the controller 100 may analyze a change of a rotation angle, based on the number of pulses outputted from the encoder 110.

Furthermore, the encoder 110 may output A and B pulses having a phase difference of 90 degrees from each other, that is, a duty ratio of 50%, in order to determine the rotation direction of the motor. That is, when the motor is rotated in the forward direction, the phase of the A pulse leads the phase of the B pulse by 90 degrees, as illustrated in FIG. 3. On the other hand, when the motor is rotated in the backward direction, the phase of the B pulse leads the phase of the A pulse by 90 degrees.

The controller 100 may receive the A and B pulses from the encoder 110 and measure the information of the pulses, during a first reference time. The first reference time may indicate a reference time for a motor speed measurement cycle. The apparatus for measuring speed of an MDPS drive motor in accordance with the embodiment of the present invention may measure the speed of the motor at each integer multiple of the first reference time. Furthermore, the first reference time may be basically preset, but designed to various values according to the intention of a user and the specification of a vehicle. Furthermore, the pulse information may include a pulse number obtained by multiplying the number of the A and B pulses by four, the cycle information of the A pulse, and the cycle information of the B pulse, and a pulse state.

The pulse number obtained by multiplying the number of the A and B pulses by four (hereafter, referred to as multiplied-by-four pulse number) may indicate that rising edges and falling edges of the A and B pulses are distinguished to increase the number of the A and B pulses by four times. That is, within one cycle of the A pulse illustrated in FIG. 3, four time points exist. The four time points may include an A pulse rising time, a B pulse rising time, an A pulse falling time, and a B pulse falling time. The controller 100 may measure the pulse number by distinguishing the time points and multiplying the number of the A and B pulses by four. Through the multiplication-by-four, the controller 100 may increase the resolution of the encoder by four times. Thus, the controller 100 may measure the speed of the motor more precisely than when the pulse number is not multiplied. In the present embodiment, the pulse number may indicate a pulse number obtained by multiplying the number of pulses inputted during a predetermined time (first reference time) by four.

The cycle information of the A pulse may indicate information on the time between the respective pulses of the A pulse, that is, information on a rising time or falling time of the A pulse. For example, the controller 100 may generate a clock pulse at a higher frequency than an output pulse of the encoder 110, and measure the cycle information of the A pulse by counting the clock pulse at each of rising and falling times of the A pulse. In addition, the controller 100 may measure the cycle information of the A pulse by counting only the rising times or falling times of the A pulse, without counting both of the rising and falling times of the A pulse. The cycle information of the B pulse may be measured in the same manner as the cycle information of the A pulse.

The pulse state may indicate a state which is divided depending on whether the A and B pulses are high or low. That is, as illustrated in FIG. 3, the pulse state may be divided into when the A pulse is high and the B pulse is low (S1), when the A pulse is low and the B pulse is high (S2), when both of the A and B pulses are high (S3), and when both of the A and B pulses are low (S4).

The controller 100 may measure the information of the pulses during the first reference time. Then, the controller 100 may receive the A and B pulses from the encoder 110 again during the first reference time, and remeasure the information of the pulses. That is, the controller 100 may measure the information of the pulses two times, and check whether the sampling time (first reference time) is synchronized with the pulses.

Furthermore, the controller 100 may select any one of the first-measured pulse information and the remeasured pulse information as data for calculating the speed of the motor, based on the first-measured pulse information and the remeasured pulse information. That is, the controller 100 may select pulse information which is estimated to be normally synchronized, between the two pieces of pulse information, as the data for calculating motor speed, based on the pulse information. Then, the controller 100 may calculate the speed of the MDPS drive motor, based on the selected data.

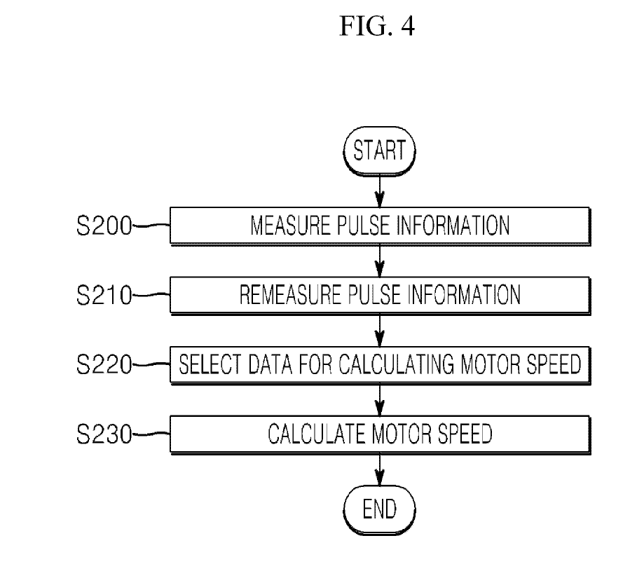

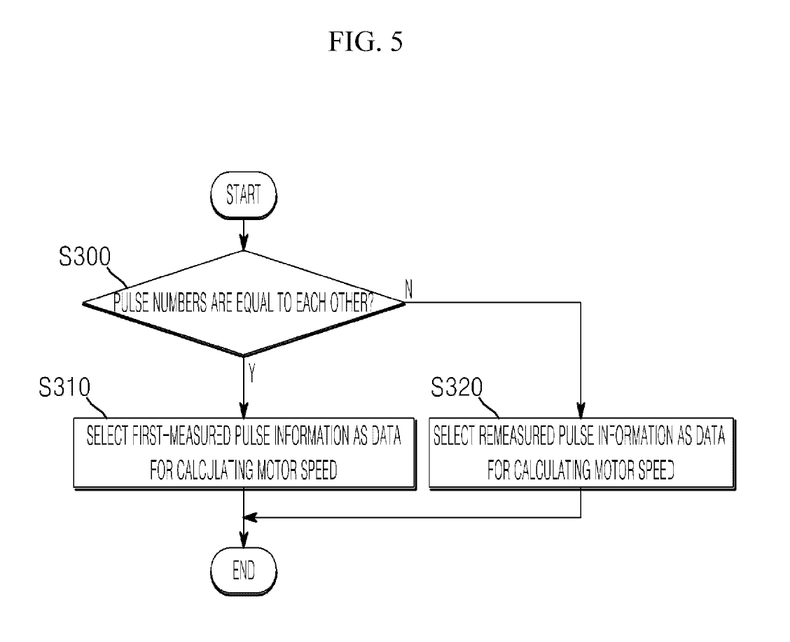

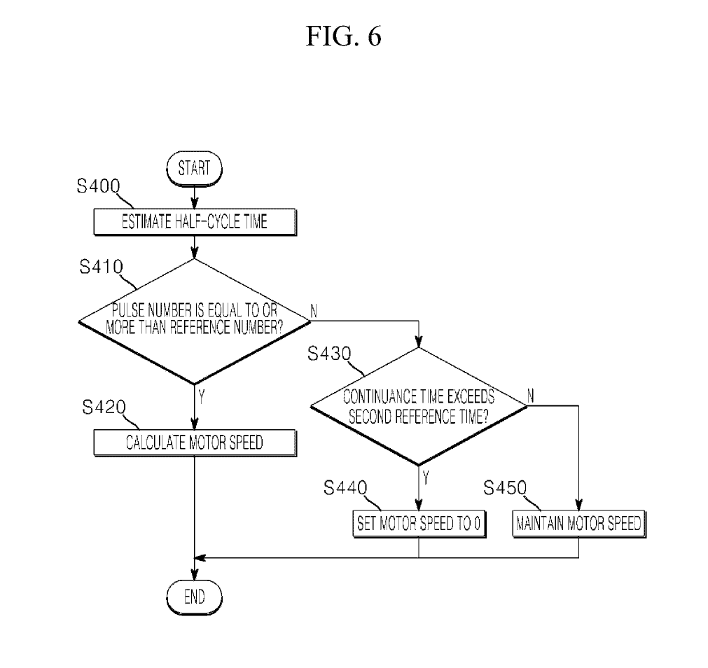

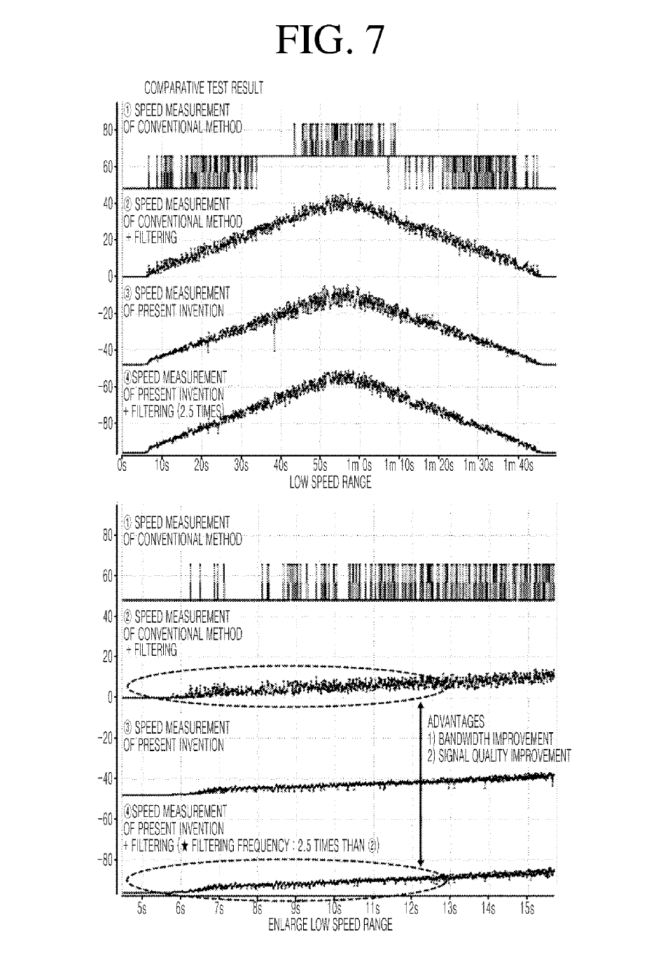

FIG. 4 is a flowchart for describing a method for measuring speed of an MDPS drive motor in accordance with an embodiment of the present invention. FIG. 5 is a flowchart for describing a step of selecting data for calculating the speed of a motor in the method for measuring speed of an MDPS drive motor in accordance with the embodiment of the present invention. FIG. 6 is a flowchart for describing a step of calculating the speed of the motor in the method for measuring speed of an MDPS drive motor in accordance with the embodiment of the present invention. FIG. 7 is a diagram comparatively illustrating a speed measurement result of the method for measuring speed of an MDPS drive motor in accordance with the embodiment of the present invention and a speed measurement result of another method. Referring to FIGS. 4 to 7, the method for measuring speed of an MDPS drive motor in accordance with the embodiment of the present invention will be described as follows.

As illustrated in FIG. 4, the controller 100 may receive A and B pulses from the encoder 110 during a first reference time and measure information of the pulses, at step S200. The first reference time may indicate a reference time for a motor speed measurement cycle. The apparatus for measuring speed of an MDPS drive motor in accordance with the embodiment of the present invention may measure the speed of the motor at each integer multiple of the first reference time. Furthermore, the pulse information may include a pulse number obtained by multiplying the number of the A and B pulses by four, information on the cycle of the A pulse, information on the cycle of the B pulse, and a pulse state.

After step S200, the controller 100 may receive the A and B pulses from the encoder 110 again during the first reference time and remeasure the information of the pulses, at step S210. That is, the controller 100 may measure the information of the pulses two times, and check whether the sampling time (first reference time) is synchronized with the pulses.

Then, the controller 100 may select any one of the pulse information measured at step S200 and the pulse information measured at step S210 as data for calculating the speed of the motor, based on the pulse information measured at step S200 and the pulse information measured at step S210, at step S220. That is, the controller 100 may select pulse information which is estimated to be normally synchronized, between the two pieces of pulse information, as the data for calculating the motor speed. Referring to FIG. 5, step S220 will be described in more detail as follows.

As illustrated in FIG. 5, the controller 100 may check whether the multiplied-by-four pulse number contained in the pulse information measured at step S200 is equal to the multiplied-by-four pulse number contained in the pulse information measured at step S210, at step S300.

When it is checked at step S300 that the multiplied-by-four pulse number contained in the pulse information measured at step S200 is equal to the multiplied-by-four pulse number contained in the pulse information measured at step S210, the controller 100 may select the pulse information measured at step S200 as data for calculating the speed of the motor, at step S310.

On the other hand, when it is checked at step S300 that the multiplied-by-four pulse number contained in the pulse information measured at step S200 is different from the multiplied-by-four pulse number contained in the pulse information measured at step S210, the controller 100 may select the pulse information measured at step S210 as data for calculating the speed of the motor, at step S320. That is, when it is estimated that synchronization was not normally achieved or the speed of the motor was changed due to a difference between the multiplied-by-four pulse numbers, the controller 100 may calculate the speed of the motor using the pulse information of step S210, which has been more recently measured. On the other hand, when it is estimated that synchronization was normally achieved or the speed of the motor was not significantly changed due to a difference between the multiplied-by-four pulse numbers, the controller 100 may calculate the speed of the motor using the pulse information measured at step S200.

After step S220 of FIG. 4, the controller 100 may calculate the speed of the motor based on the data selected at step S220, at step S230. Referring to FIG. 6, step S230 will be described in more detail as follows.

As illustrated in FIG. 6, the controller 100 may estimate the half-cycle time of any one of the A and B pulses, based on the data selected at step S220. For example, the controller 100 may generate a clock pulse at a higher frequency than an output pulse of the encoder 110, and estimate the half-cycle time of the A pulse, based on the cycle information of the A pulse, which is measured by counting the clock pulse at each of rising and falling times of the A pulse.

That is, the controller 100 may estimate the half-cycle time of the A pulse by calculating a difference between the number of clock pulses, counted at the last rising time of the A pulse, and the number of clock pulses, counted at the last falling time of the A pulse. Furthermore, the controller 100 may calculate the half-cycle time of the A pulse by dividing the calculated difference by the frequency of the clock pulse. When the controller 100 estimates the half-cycle time at step S400, it may not only indicate the case in which the controller 100 calculates the half-cycle time of the A pulse, but also indicate the case in which the controller 100 calculates only the difference between the counted clock pulse pulses.

Furthermore, at step S400, the controller 100 may determine the rotation direction of the motor based on the pulse state contained in the data selected at step S220, select any one of the A and B pulses based the determined rotation direction of the motor and the last value of the pulse state contained in the data selected at step S220, and estimate the half-cycle time.

At this time, the controller 100 may determine the rotation direction of the motor, based on the change of the pulse state. As illustrated in FIG. 3, when the motor is rotated in the forward direction, the pulse state may be changed in order of S1->S3->S2->S0->S1-> . . . . On the other hand, when the motor is rotated in the backward direction, the pulse state may be changed in order of S0->S2->S3->S1->S0-> . . . . Thus, the controller 100 may determine the rotation direction of the motor, based on the change of the pulse state.

When the motor is rotated in the forward direction, the controller 100 may estimate the half-cycle time of the A pulse in case where the last value of the pulse state contained in the data selected at step S220 is any one of S1 and S2, and estimate the half-cycle time of the B pulse in case where the last value is any one of S3 and S4. On the other hand, when the motor is rotated in the backward direction, the controller 100 may estimate the half-cycle time of the B pulse in case where the last value is any one of S1 and S2, and estimate the half-cycle time of the A pulse in case where the last value is any one of S3 and S4.

When the motor is rotated in the forward direction, a change of the last input pulse is A pulse rising in case where the last value of the pulse state is S1, A pulse falling in case where the last value of the pulse state is S2, B pulse rising in case where the last value of the pulse state is S3, or B pulse falling in case where the last value of the pulse state is S4. On the other hand, when the motor is rotated in the backward direction, a change of the last input pulse is B pulse falling in case where the last value of the pulse state is S1, B pulse rising in case where the last value of the pulse state is S2, A pulse rising in case where the last value of the pulse state is S3, or A pulse falling in case where the last value of the pulse state is S4. That is, the controller 100 may select a pulse which was later changed (most recently measured) between the A and B pulses and estimate the half-cycle time, in order to estimate a more accurate half-time cycle.

After step S400, the controller 100 may check whether the multiplied-by-four pulse number contained in the data selected at step S220 is equal to or more than the reference number, at step S410. The reference number may indicate a reference pulse number which is used to prevent an overflow of the clock pulse count when the time during which a driver does not perform steering continues, and to reduce an error at an ultra low-speed region. The reference number may be basically preset, but designed to various values depending on the intention of a user or the specification of a vehicle.

When it is checked at step S410 that the multiplied-by-four pulse number contained in the data selected at step S200 is equal to or more than the reference number, the controller 100 may calculate the speed of the motor, based on the multiplied-by-four pulse number contained in the data selected at step S220 and the time estimated at step S400, at step S420. At this time, the controller 100 may calculate the RPM of the motor through Equation 1 below.

$$\frac{15 \times pulse number}{PPR \times ( first reference time + \frac{half cycle time}{2} )} \qquad [ Equation 1 ]$$

Here, PPR represents the number of output pulses per revolution of the encoder. That is, the controller 100 may calculate the speed of the motor based on the conventional M method. However, the controller 100 may more precisely calculate the speed of the motor through error correction using a value obtained by dividing the half-cycle time of the pulse by 2 (pulse cycle multiplied by four).

On the other hand, when it is checked at step S410 that the multiplied-by-four pulse number contained in the data selected at step S220 is less than the reference number, the controller 100 may check whether the continuance time during which the pulse number is less than the reference number exceeded a second reference time, at step S430. The second reference time may indicate a reference time for preventing an overflow of the clock pulse count and reducing an error at an ultra low-speed period, when the time during which a driver does not perform steering continues. The second reference time may be basically preset, but designed to various values depending on the intention of a user, the specification of the vehicle and the like.

When it is checked at step S430 that the continuance time during which the pulse number checked at step S410 is less than the reference number exceeded the second reference time, the controller 100 may set the speed of the motor to 0, at step S440. That is, when the driver does not perform steering until the continuance time exceeds the second reference time, the controller 100 may prevent a count overflow by setting the speed of the motor to 0.

On the other hand, when it is checked at step S430 that the continuance time during which the pulse number is less than the reference number did exceed the second reference time, the controller 100 may maintain the speed of the motor as it is, at step S450. That is, when the continuance time during which the driver does not perform steering did not exceed the second reference time, the controller 100 may maintain the speed of the motor as it is. Thus, it is possible to prevent a feel of strangeness, which the user may have according to a sudden change of the motor speed. Furthermore, the controller 100 may calculate the speed of the motor based on the continuance time during which the multiplied-by-four pulse number contained in the data selected at step S220 and the pulse number checked at step S410 are less than the reference number, or determine the speed of the motor according to a preset condition, thereby preventing a variation of the motor speed measurement cycle at thane ultra low-speed region.

Referring to FIG. 7, a speed measurement result of the method for measuring speed of an MDPS drive motor in accordance with the present embodiment and a speed measurement result of another method will be comparatively described as follows.

In a general MDPS system, a measured motor speed is subjected to a filtering process and then used as a parameter for performing control logic of the motor. At this time, a predetermined delay may occur due to the influence of a filtering frequency. Since such a delay can serve as a performance reduction factor of the steering control logic, the delay needs to be minimized. When the bandwidth of the filter is increased in order to minimize the delay, a side effect may occur. For example, the influence of noise may increase. In the present embodiment, however, when the speed of the motor is measured through the method for measuring speed of an MDPS drive motor in accordance with the embodiment of the present invention, the quality of the measured signal can be improved. Thus, although the filtering frequency is increased by 2.5 times, the influence of noise may not increase.

Furthermore, the method for measuring speed of an MDPS drive motor in accordance with the embodiment of the present invention may be repetitively performed during operation of the vehicle, and continuously measure the speed of the motor. Furthermore, the method for measuring speed of an MDPS drive motor in accordance with the embodiment of the present invention can measure the speed of the motor at each time obtained by doubling the first reference time, and thus measure the speed of the motor without a variation of the motor speed measurement cycle.

In a method for measuring speed of an MDPS drive motor in accordance with another embodiment of the present invention, when the multiplied-by-four pulse number contained in the data selected at step S220 is equal to or more than the reference number at the step of calculating the speed of the motor, the controller 100 may estimate the half-cycle time of any one of the A and B pulses based on the data selected at step S220, and calculate the speed of the motor based on the multiplied-by-four pulse number contained in the data selected at step S220 and the estimated time.

Furthermore, in a method for measuring speed of an MDPS drive motor in accordance with another embodiment of the present invention, the controller 100 may receive A and B pulses from the encoder 110 during the first reference time and measure a multiplied-by-four pulse number and a multiplied-by-four pulse cycle. When the measured pulse number is equal to or more than the reference number, the controller 100 may calculate the speed of the motor based on the measured pulse number and the measured pulse cycle, and when the measured pulse number is less than the reference number, the controller 100 may determine the speed of the motor based on the continuance time during which the pulse number is less than the reference number. At this time, the controller 100 may calculate the RPM of the motor through Equation 2 below.

$$\frac{15 \times pulse number}{PPR \times ( first reference time + pulse cycle )} \qquad [ Equation 2 ]$$

Here, PPR represents the number of output pulses per rotation of the encoder. Furthermore, the rest steps of the method for measuring speed of an MDPS drive motor in accordance with the present embodiment may be performed in the same manner as the method for measuring speed of an MDPS drive motor in accordance with the above-described embodiment.

The apparatus and method for measuring speed of an MDPS drive motor in accordance with the embodiments of the present invention may calculate the speed of the motor based on the multiplied-by-four pulse number, the pulse cycle, and the pulse state, thereby improving the quality of the speed measurement operation for the MPDS drive motor.

Although embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A method for measuring speed of a motor driven power steering (MDPS) drive motor, comprising:
receiving, by a controller, A and B pulses having a phase difference of 90 degrees from an encoder during a first reference time, and measuring information of the pulses;
receiving A and B pulses having a phase difference of 90 degrees from the encoder again during the first reference time, and remeasuring information of the pulses;
selecting any one of the measured pulse information and the remeasured pulse information as data for calculating the speed of the motor, based on the measured pulse information and the remeasured pulse information; and
calculating the speed of the motor, based on the selected data.

2. The method of claim 1, wherein the pulse information comprises a pulse number obtained by multiplying the number of the A and B pulses by four, information on the cycle of the A pulse, information on the cycle of the B pulse, and a pulse state, and
in the selecting of any one of the measured pulse information and the remeasured pulse information as the data for calculating the speed of the motor,
the controller selects the measured pulse information as the data for calculating the speed of the motor when the multiplied-by-four pulse number contained in the measured pulse information is equal to the multiplied-by-four pulse number contained in the remeasured pulse information, and selects the remeasured pulse information as the data for calculating the speed of the motor when the multiplied-by-four pulse number contained in the measured pulse information is different from the multiplied-by-four pulse number contained in the remeasured pulse information.

3. The method of claim 2, wherein the calculating of the speed of the motor comprises:
estimating, by the controller, a half-cycle time of any one of the A and B pulses, based on the selected data;
when the multiplied-by-four pulse number contained in the selected data is equal to or more than a reference number, calculating the speed of the motor based on the multiplied-by-four pulse number contained in the selected data and the estimated time; and
when the multiplied-by-four pulse number contained in the selected data is less than the reference number, determining the speed of the motor based on the continuance time during which the pulse number is less than the reference number.

4. The method of claim 3, wherein the determining of the speed of the motor comprises:
setting, by the controller, the speed of the motor to 0 when the continuance time exceeds a second reference time; and
maintaining the speed of the motor when the continuance time does not exceed the second reference time.

5. The method of claim 3, wherein the pulse state is divided into when the A pulse is high and the B pulse is low (S1), when the A pulse is low and the B pulse is high (S2), when both of the A and B pulses are high (S3), and when both of the A and B pulses are low (S4), and
the estimating of the half-cycle time comprises:
determining, by the controller, the rotation direction of the motor based on a pulse state contained in the selected data;
estimating the half-cycle time of the A pulse, when the determined rotation direction of the motor is forward and the last value of the pulse state contained in the selected data is any one of S1 and S2;
estimating the half-cycle time of the B pulse, when the rotation direction is forward and the last value is any one of S3 and S4;
estimating the half-cycle time of the B pulse, when the rotation direction is backward and the last value is any one of S1 and S2; and
estimating the half-cycle time of the A pulse, when the rotation direction is backward and the last value is any one of S3 and S4.

6. The method of claim 3, wherein in the calculating of the speed of the motor,
the controller calculates the RPM of the motor through the following equation:
$$\frac{15 \times pulse number}{PPR \times ( first reference time + \frac{half cycle time}{2} )}$$
where PPR represents the number of output pulses per revolution of the encoder.

7. The method of claim 2, wherein the calculating of the speed of the motor comprises:
estimating, by the controller, a half-cycle time of any one of the A and B pulses based on the selected data, when the multiplied-by-four pulse number contained in the selected data is equal to or more than a reference number;
calculating the speed of the motor based on the multiplied-by-four pulse number contained in the selected data and the estimated time;
setting the speed of the motor to 0, when the multiplied-by-four pulse number contained in the selected data is less than the reference number and the continuance time during which the pulse number is less than the reference number exceeds the second reference time; and
maintaining the speed of the motor, when the multiplied-by-four pulse number contained in the selected data is less than the reference number and the continuance time during which the pulse number is less than the reference number does not exceed the second reference time.

8. The method of claim 7, wherein the pulse state is divided into when the A pulse is high and the B pulse is low (S1), when the A pulse is low and the B pulse is high (S2), when both of the A and B pulses are high (S3), and when both of the A and B pulses are low (S4), and
the estimating of the half-cycle time comprises:
determining, by the controller, the rotation direction of the motor based on a pulse state contained in the selected data;
estimating the half-cycle time of the A pulse, when the determined rotation direction of the motor is forward and the last value of the pulse state contained in the selected data is any one of S1 and S2;
estimating the half-cycle time of the B pulse, when the rotation direction is forward and the last value is any one of S3 and S4;
estimating the half-cycle time of the B pulse, when the rotation direction is backward and the last value is any one of S1 and S2; and
estimating the half-cycle time of the A pulse, when the rotation direction is backward and the last value is any one of S3 and S4.

9. The method of claim 7, wherein in the calculating of the speed of the motor,
the controller calculates the RPM of the motor through the following equation:
$$\frac{15 \times pulse number}{PPR \times ( first reference time + \frac{half cycle time}{2} )}$$
where PPR represents the number of output pulses per revolution of the encoder.

10. A method for measuring speed of an MDPS drive motor, comprising:
receiving, by a controller, A and B pulses having a phase difference of 90 degrees from an encoder during a first reference time, and measuring a multiplied-by-four pulse number and a multiplied-by-four pulse cycle;
when the measured pulse number is equal to or more than a reference number, calculating the speed of the motor based on the measured pulse number and the measured pulse cycle; and
when the measured pulse number is less than the reference number, determining the speed of the motor based on a continuance time during which the pulse number is less than the reference number.

11. The method of claim 10, wherein the determining of the speed of the motor comprises:
setting, by the controller, the speed of the motor to 0, when the continuance time exceeds a second reference time; and
maintaining the speed of the motor, when the continuance time does not exceed the second reference time.

12. The method of claim 10, wherein in the calculating of the speed of the motor,
the controller calculates the RPM of the motor through the following equation:
$$\frac{15 \times pulse number}{PPR \times ( first reference time + pulse cycle )}$$
where PPR represents the number of output pulses per revolution of the encoder.

13. An apparatus for measuring speed of a motor driven power steering (MDPS) drive motor, comprising:
an encoder configured to output A and B pulses having a phase difference of 90 degrees, as the motor is rotated; and
a controller configured to measure information of A and B pulses received from the encoder during a first reference time, then remeasure information of A and B pulses received from the encoder again during the first reference time, select any one of the measured pulse information and the remeasured pulse information as data for calculating the speed of the motor, based on the measured pulse information and the remeasured pulse information, and calculate the speed of the motor based on the selected data.

14. The apparatus of claim 13, wherein the pulse information comprises a pulse number obtained by multiplying the number of the A and B pulses by four, information on the cycle of the A pulse, information on the cycle of the B pulse, and a pulse state, and
when selecting the data for calculating the speed of the motor, the controller selects the measured pulse information as the data for calculating the speed of the motor in case where the multiplied-by-four pulse number contained in the measured pulse information is equal to the multiplied-by-four pulse number contained in the remeasured pulse information, and selects the remeasured pulse information as the data for calculating the speed of the motor in case where the multiplied-by-four pulse number contained in the measured pulse information is different from the multiplied-by-four pulse number contained in the remeasured pulse information.
